(19) United States
(12) Patent Application Publication
(10) Pub. No.: US 2015/0254975 A1
(43) Pub. Date: Sep. 10, 2015

(54) SMART MOBILE TERMINAL REMOTE CONTROL SYSTEM

(71) Applicant: IPGoal Microelectronics (Sichuan) Co., Ltd., Chengdu (CN)

(72) Inventors: Zhengxian ZOU, Chengdu (CN); Xiaolin XIE, Chengdu (CN)

(21) Appl. No.: 14/719,249

(22) Filed: May 21, 2015

(30) Foreign Application Priority Data
Mar. 11, 2015 (CN) 201510105490.6

(51) Int. Cl. G08C 23/04

(52) U.S. Cl. CPC G08C 23/04; G08C 2201/30

(57) ABSTRACT

A smart mobile terminal remote control system includes a smart mobile terminal, a displaying device, a remote controller and a controller, the displaying device is configured to display an operation interface of the smart mobile terminal in real time, the controller is connected to the smart mobile terminal and the remote controller respectively and configured to emit an infrared light and receive the infrared light reflected by the remote controller, obtain information of the remote controller according to the infrared light received, generate a control command according to the information, and send the control command to the smart mobile terminal which responds to the control command. The smart mobile terminal remote control system makes the smart mobile terminal transfer data to other displaying devices smoothly and get a better displaying effect.

### RELATED APPLICATIONS

This application claims the benefit of priority to Chinese Patent Application No. 201510105490.6, filed on Mar. 11, 2015, which is hereby incorporated by reference in its entirety.

### FIELD OF THE INVENTION

The present invention relates to remote control technology field, and more particularly to a smart mobile terminal remote control system.

### BACKGROUND OF THE INVENTION

As the development of the technology, various smart mobile terminals have been developed with each passing day, making uses of the smart mobile terminals become more and more convenient and diverse. For example, the smart mobile terminal can output its analog or digital signal to one other displaying device via a wired or wireless connection way for the purpose of obtaining the displaying effect with a larger size. Such a function may be well applied to some application scenarios which have poor displaying effect caused by displaying on the smart mobile terminal which has a small display screen, such as watching high-definition movies, playing big games, showing videos to others or showing PPT documents.

In the prior art, although the data on the smart mobile terminal can be transferred to the other displaying device smoothly when the smart mobile terminal is connected to the other displaying device in a wired connection way, the length of the data cable connected there is usually limited so that the distance between the smart mobile terminal and the other displaying device is too short, thereby users can't get a better displaying effect through the other displaying device which has a big screen in this case. On the other hand, although a wireless connection between the smart mobile terminal and the other displaying device overcomes a distance limitation caused by the wired connection way, it's unable to transfer data smoothly when the amount of the data transferred is large, and therefore the displaying effect on the other displaying device is greatly reduced. Besides, it's necessary for the user to operate the smart mobile terminal within a short distance in this case, thus a normal data transfer can not be maintained if the smart mobile terminal is on charging or using other functions. For example, if the smart mobile terminal is a smart phone, data transfer between the smart phone and the other displaying device is disabled when the smart phone is on a call or charged. By this token, a wireless connection way also limits the cooperation between the smart mobile terminal and the other displaying device for the purpose of obtaining a better displaying effect.

Therefore, in order to make the smart mobile terminal be able to transfer data to the other displaying device flexibly and conveniently and get a better displaying effect, it is necessary to provide an improved smart mobile terminal remote control system.

### SUMMARY OF THE INVENTION

An objective of the present invention is to provide a smart mobile terminal remote control system which is used for remotely controlling a smart mobile terminal, thereby making the smart mobile terminal be able to transfer data to other displaying devices flexibly and conveniently, and further get a better displaying effect.

To achieve the objective, a smart mobile terminal remote control system includes a smart mobile terminal, a displaying device, a remote controller and a controller, and the displaying device is connected to the smart mobile terminal through a data cable and configured to display an operation interface of the smart mobile terminal in real time, and the controller is connected to the smart mobile terminal and the remote controller respectively and configured to emit an infrared light, and the remote controller is configured to reflect the infrared light, and the controller is further configured to receive the infrared light reflected by the remote controller, obtain information of the remote controller according to the infrared light received, generate a control command according to the information, and send the control command to the smart mobile terminal which responds to the control command.

Preferably, the information of the remote controller comprises reflection area information, reflection strength information and position information of the remote controller relative to the controller.

Preferably, the remote controller is controlled by a user's operation made on a displaying screen of the displaying device to change the position information of the remote controller relative to the controller, and the controller is configured to generate corresponding control commands according to changes of the position information.

Preferably, the remote controller is controlled by a user's operation made on a displaying screen of the displaying device to change the reflection area information of the remote controller, and the controller is configured to generate different control commands according to changes of the reflection area information.

Preferably, the remote controller is controlled by a user's operation made on a displaying screen of the displaying device to change the reflection strength information of the remote controller, and the controller is configured to generate different control commands according to changes of the reflection strength information.

Preferably, the smart mobile terminal is a smart phone or a tablet computer.

Preferably, the controller is configured to support a multi-point control and receive infrared lights reflected by multiple remote controllers simultaneously.

Preferably, the remote controller is a remote control handle which has a reflector.

Preferably, the displaying device is a television, a display screen or a displayer.

In comparison with the prior art, since the controller is connected to the smart mobile terminal and the remote controller respectively and configured to emit an infrared light, the remote controller is configured to reflect the infrared light, and the controller is further configured to receive the infrared light reflected by the remote controller, obtain information of the remote controller according to the infrared light received, generate a control command according to the information of the remote controller and send the control command to the smart mobile terminal, thereby the smart mobile terminal is remotely controlled by using the controller in concert with the remote controller, and the smart mobile terminal is able to transfer data to the displaying device flexibly and conveniently, and finally obtaining a better displaying effect.

The present invention will become more apparent from the following detailed description when taken in conjunction with the accompanying drawings used to illustrate embodiments of the invention.

### BRIEF DESCRIPTION OF THE DRAWINGS

FIG. 1 is a frame diagram of a smart mobile terminal remote control system according to the present invention.

### DETAILED DESCRIPTION OF ILLUSTRATED EMBODIMENTS

Preferred embodiments of the present invention will be described taking in conjunction with the accompanying drawings below, and a similar component label in the drawings refers to a similar component. As noted above, the present invention provides a smart mobile terminal remote control system which is used for remotely controlling the smart mobile terminal, thereby making the smart mobile terminal be able to transfer data to other displaying devices smoothly, and further get a better displaying effect.

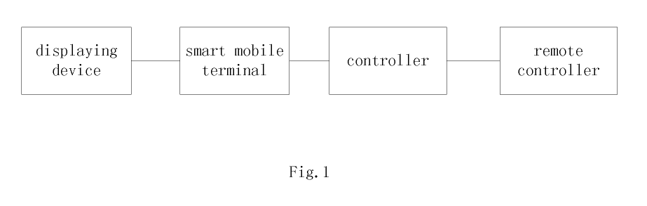

Please refer to FIG. 1, the smart mobile terminal remote control system according to the present invention includes a smart mobile terminal, a displaying device, a remote controller and a controller. And the displaying device is connected with the smart mobile terminal which transfers its own data to the displaying device through a data cable, and then the displaying device displays an operation interface of the smart mobile terminal in real time. That is, the content displayed on the own screen of the smart mobile terminal is displayed on the displaying device which usually has a big display screen, therefore users of the smart mobile terminal get a better displaying effect. And the controller is connected to the smart mobile terminal and the remote controller respectively. Specifically, the controller is connected to the smart mobile terminal via a wired or wireless way as long as control commands of the controller can be transferred to the smart mobile terminal normally. And the controller is configured to emit an infrared light and receive the infrared light reflected by the remote controller, obtain information of the remote controller according to the infrared light received, generate a control command according to the information of the remote controller, and send the control command to the smart mobile terminal which is under control of the controller by responding to the control command, and thus the smart mobile terminal is controlled by the remote controller. Furthermore, the information of the remote controller includes reflection area information, reflection strength information and position information of the remote controller relative to the controller. Concretely, when the users move the remote controller correspondingly according to the content displayed on the displaying device, the position of the remote controller relative to the controller is changed, thereby the reflection area of the infrared light reflected by the remote controller, the reflection strength and the position of the remote controller relative to the controller are changed accordingly, and then the information of the remote controller obtained by the controller according to the infrared light received is changed accordingly, furthermore, the control command generated by the controller is changed, and finally realizing a remotely control for the smart mobile terminal.

In preferred embodiments of the present invention, the smart mobile terminal is a smart phone or a tablet computer. And since the smart phone or the tablet computer is generally used, the screen of the smart phone or the tablet computer is usually designed not very large so that it can be taken conveniently, so in order to get a better displaying effect, the smart phone or the tablet computer is required to be connected to the displaying device. For example, when watching high-definition movies or play big games, the users can get a better visual enjoyment by connecting the smart phone or the tablet computer to the displaying device. Besides, the controller in the present invention is configured to support a multi-point control and receive infrared lights reflected by multiple remote controllers simultaneously, thereby multiple remote controllers can be simultaneously used in combination with each other to control the smart mobile terminal, and as a result, the remote control for the smart mobile terminal is more flexibly and conveniently. Furthermore, the remote controller is a remote control handle which has a reflector. And since the remote controller in the present invention realizes a remote control for the smart mobile terminal by reflecting the infrared light emitted by the controller, the remote control for the smart mobile terminal can be realized easily and conveniently by the remote control handle which has a reflector. In addition, the displaying device in the present invention is a television, a display screen or a displayer, which is not limited to this, and other displaying devices which have appropriate size screens are fine.

As one preferred embodiment of the present invention, the remote controller is controlled by a user's operation made on a displaying screen of the displaying device to change the position information of the remote controller relative to the controller, and the controller is configured to generate corresponding control commands according to changes of the position information. For example, when the remote controller (remote control handle) is moved up and down, a control point of the smart mobile terminal is moved up and down on the screen of the displaying device correspondingly so that the user can move the control point to a correspondingly position by observing the screen of the displaying device.

As another preferred embodiment of the present invention, the remote controller is controlled by a user's operation made on a displaying screen of the displaying device to change the reflection area information of the remote controller, and the controller is configured to generate different control commands according to changes of the reflection area information. In the present invention, the controller is usually mounted on a wall or other objects fixedly so that the radiation range and radiation distance of the infrared light emitted by the controller are maintained constant. And when the user moves the remote controller, the area of the infrared light received by the remote controller is changed, thereby the reflection area information of the remote controller is changed as a result, so that the controller will generate different control commands according to changes of the reflection area information to realize different control operations for the smart mobile terminal finally. Moreover, the actual desired control operation implemented by generating the change of the reflection area information can be set according to a specific application environment.

As the other preferred embodiment of the present invention, the remote controller is controlled by a user's operation made on a displaying screen of the displaying device to change the reflection strength information of the remote controller, and the controller is configured to generate different control commands according to changes of the reflection strength information In the present invention, the controller is usually mounted on a wall or other objects fixedly so that the radiation range and the radiation distance of the infrared light emitted by the controller are constant, and the reflection strength at the same distance is constant as well. When the user moves the remote controller to change the distance between the remote controller and the controller, the reflection strength information of the remote controller is changed, and then the controller will generate different control commands according to the changes of the reflection strength information, finally realize different control operations for the smart mobile terminal. Moreover, the actual desired control operation implemented by generating the change of the reflection strength information can be set according to a specific application environment.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A smart mobile terminal remote control system, comprising:
a smart mobile terminal;
a displaying device connected to the smart mobile terminal through a data cable and configured to display an operation interface of the smart mobile terminal in real time;
a remote controller; and
a controller connected to the smart mobile terminal and the remote controller respectively and configured to emit an infrared light;
wherein the remote controller is configured to reflect the infrared light, and the controller is configured to receive the infrared light reflected by the remote controller, obtain information of the remote controller according to the infrared light received, generate a control command according to the information, and send the control command to the smart mobile terminal which responds to the control command.

2. The system according to claim 1, wherein the information of the remote controller comprises reflection area information, reflection strength information and position information of the remote controller relative to the controller.

3. The system according to claim 2, wherein the remote controller is controlled by a user's operation made on a displaying screen of the displaying device to change the position information of the remote controller relative to the controller, and the controller is configured to generate corresponding control commands according to changes of the position information.

4. The system according to claim 2, wherein the remote controller is controlled by a user's operation made on a displaying screen of the displaying device to change the reflection area information of the remote controller, and the controller is configured to generate different control commands according to changes of the reflection area information.

5. The system according to claim 2, wherein the remote controller is controlled by a user's operation made on a displaying screen of the displaying device to change the reflection strength information of the remote controller, and the controller is configured to generate different control commands according to changes of the reflection strength information.

6. The system according to claim 2, wherein the smart mobile terminal is a smart phone or a tablet computer.

7. The system according to claim 2, wherein the controller is configured to support a multi-point control and receive infrared lights reflected by multiple remote controllers simultaneously.

8. The system according to claim 2, wherein the remote controller is a remote control handle which has a reflector.

9. The system according to claim 2, wherein the displaying device is a television, a display screen or a displayer.
